(19) United States
(12) Patent Application Publication
(10) Pub. No.: US 2026/0327055 A1
(43) Pub. Date: Oct. 22, 2026

(54) RUNWAY LIFT WITH LOAD SENSING AND METHODS OF USE

(71) Applicant: Vehicle Service Group, LLC, Madison, IN (US)

(72) Inventors: Gerry Lauderbaugh, Dupont, IN (US); Robert William Elliott, Madison, IN (US)

(73) Assignee: Vehicle Service Group, LLC, Madison, IN (US)

(21) Appl. No.: 19/646,180

(22) Filed: Apr. 13, 2026

Related U.S. Application Data
(60) Provisional application No. 63/790,004, filed on Apr. 16, 2025.

(51) Int. Cl. B66F 17/00; B66F 7/20; B66F 7/28

(52) U.S. Cl. CPC B66F 17/00; B66F 7/20; B66F 7/28

(57) ABSTRACT

A runway lift includes a front lift, a rear lift, a pair of runways extending between the front lift and the rear lift, a front lift loading gauge, a rear lift loading gauge, and a control unit in communication with both the front lift loading gauge and the rear lift loading gauge. The front lift and the rear lift can actuate the pair of runways between a lowered position and a raised position. The front lift loading gauge and the rear lift loading gauge can measure a front load data and a rear load data, respectively. The control unit can determine if the rear lift is overloaded using the front load data and determine if the rear lift is overloaded using the rear load data. Further, the control unit can generate a signal in response to determining if the front lift or the rear lift is overloaded.

This application claims priority to U.S. Pat. App. No. 63/790,004, filed Apr. 16, 2025, the disclosure of which is hereby incorporated by reference in its entirety.

### BACKGROUND

A vehicle lift is a device operable to lift a vehicle such as a car, truck, bus, etc. One type of vehicle lift is a runway lift. Such vehicle lifts operate by positioning two runways at, or near, a shop floor. When utilizing a runway lift, the vehicle may be driven or rolled onto the runways, allowing the runways to support the vehicle. Each runway may be attached to one or more lifting assemblies. The one or more lifting assemblies may be utilized to raise the runways and the supported vehicle relative to the shop floor to a desired height. Additionally, the one or more lifting assemblies may be utilized to lower the runways and the supported vehicle back towards the shop floor. Such lifting assemblies may be hydraulically actuated via pump(s) and hydraulic cylinder(s).

While a variety of runway lifts have been made and used, it is believed that no one prior to the inventor(s) has made or used an invention as described herein.

### BRIEF DESCRIPTION OF THE DRAWINGS

While the specification may conclude with claims that particularly point out and distinctly claim the invention, it is believed the present invention will be better understood from the following description of certain examples taken in conjunction with the accompanying drawings, in which like reference numerals identify the same elements and in which:

FIG. 1A is a perspective view of an illustrative four-post runway lift in a lowered position, where the four-post runway lift includes a front lift section and a rear lift section;

FIG. 1B is a perspective view of the four-post runway lift of FIG. 1A in a raised position;

FIG. 2 is a perspective view of the front lift section of the four-post runway lift of FIG. 1A, where the four-post runway lift is in a lowered position;

FIG. 3 is a perspective view of a first vertical post of the front lift section of FIG. 1A and a primary control panel of the four-post runway lift of FIG. 1A, where the four-post runway lift is in a raised position;

FIG. 4 is a schematic view of the four-post runway lift of FIG. 1A, showing internal components of the primary control panel of FIG. 3 and a secondary control panel associated with the rear lift section of the four-post runway lift;

FIG. 5 is an elevational side view of the four-post runway lift of FIG. 1A in the raised position and supporting a vehicle such that a load of the supported vehicle is primarily distributed to the front lift section of the four-post runway lift;

FIG. 6 is an elevational side view of the four-post runway lift of FIG. 1A in the raised position supporting the vehicle of FIG. 5 such that the load of the supported vehicle is evenly distributed between the front lift section and the rear lift section of the four-post runway lift;

FIG. 7 is a flowchart of an illustrative method of a control circuit of the four-post runway lift of FIG. 1A to determine if the total load of a supported vehicle, and the distribution of the total load between the front lift section and the rear lift section, is within acceptable ranges;

FIG. 8 is a flowchart of an illustrative method of a control circuit of the four-post runway lift of FIG. 1A to determine whether the load distribution of a supported vehicle is within an acceptable range;

FIG. 9 is a flowchart of an illustrative method of utilizing the four-post runway lift of FIG. 1A to raise a vehicle;

FIG. 10A is a cross-sectional view of the four-post runway lift of FIG. 1A in the lowered position;

FIG. 10B is a cross-sectional view of the four-post runway lift of FIG. 1A in the raised position;

FIG. 11A is a perspective view of a rod to yoke connection assembly of the four-post runway lift of FIG. 1A; and

FIG. 11B is a perspective view of the rod to yoke connection assembly of FIG. 11B, with a portion of the yoke removed for purposes of clarity.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the resent invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is, by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

I. Illustrative Runway Lift with Load Sensing Capabilities

### A. Overview of Illustrative Runway Lift

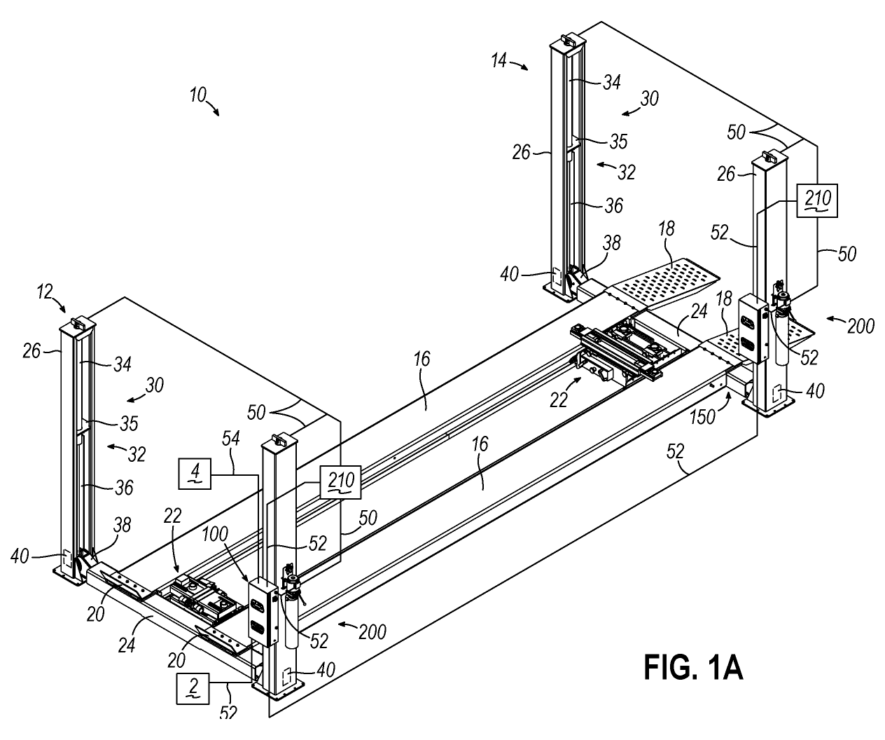

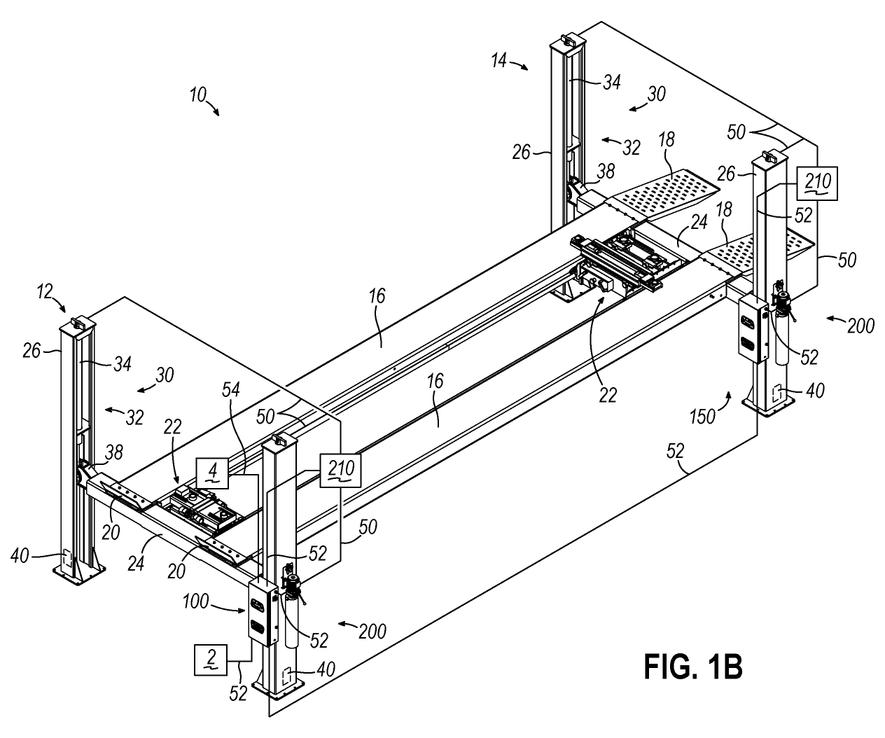

FIGS. 1A–1B show an illustrative runway lift (10) configured to move between a lowered position (see FIG. 1A), a raised position (see FIG. 1B), and a plurality of positions located therebetween. Runway lift (10) is configured to support a suitable vehicle while moving between the lowered and raised position in order to raise and lower the supported vehicle relative to a shop floor. Therefore, a technician may access the underside of a supported vehicle while runway lift (10) elevates such a vehicle above the shop floor.

Runway lift (10) includes a front lift in the form of front lift section (12), a rear lift in the form of rear lift section (14), and a pair of runways (16) extending longitudinally between front and rear lift sections (12, 14). In the current examples, both front and rear lift sections (12, 14) each include two vertical posts (26) with a respective cross-frame (24) extending laterally between the two posts (26). Front lift section (12) includes a primary control panel (100) and a hydraulic drive unit (200), each attached to a respective post (26); while rear lift section (14) includes a secondary control panel (150) and a hydraulic drive unit (200), each attached to another post (26).

An actuation assembly (30) is operatively coupled to each vertical post (26). Control panel (100) and hydraulic drive unit (200) associated with front lift section (12) are configured to drive movement of actuation assemblies (30) associated with front lift section (12); while control panels (100, 150) and hydraulic drive unit (200) associated with rear lift section (14) are configured to simultaneously drive movement of actuation assemblies (30) associated with rear lift section (14). Each actuation assembly (30) is operatively connected to a respective cross-frame (24); while cross-frames (24) are operatively connected to each runway (16).

Actuation assemblies (30) are configured to simultaneously actuate their respective cross-frame (24) along a predetermined vertical path defined by posts (26). Since cross-frames (24) are operatively coupled to runways (16), as illustrated between FIGS. 1A–1B, movement of cross-frames (24) also drives movement of runways (16) along a predetermined vertical path relative to posts (26). In the current illustrative examples, vertical posts (26) are utilized to define the vertical path which runway (16) can travel such that runway lift (10) is a four-post runway lift. However, it should be understood that runway lift (10) can include any other suitable structures configured to guide runways (16) along a predetermined vertical path as would be apparent to one skilled in the art in view of the teachings herein.

A terminating end of each runway (16) located proximate to rear lift section (14) includes a respective ramp (18); while a terminating end of each runway (16) located proximate to front lift section (12) includes a stop (20). While runways (16) are in the lowered position (see FIG. 1A), ramps (18) can facilitate loading and unloading vehicles onto runways (16). For example, vehicles can be driven/rolled onto/off runways (16) via ramps (18). Stops (20) can be utilized to inhibit a vehicle from inadvertently being advanced too far past the terminating end of runways (16) located proximate to front lift section (12).

In the current illustrative example, a pair of rolling jack lifts (22) are operatively attached to runways (16). Rolling jack lifts (22) can be selectively moved longitudinally relative to runways (16) into a desired longitudinal position. During use, rolling jack lifts (22) can be utilized in order to engage the frame and/or other suitable components of a vehicle supported on runways (16) such that wheels of a supported vehicle are temporarily elevated off runways (16). Therefore, rolling jack lifts (22) can allow a technician to service wheels and/or tires of a vehicle raised by runways lift (10).

As mentioned above, actuator assemblies (30) are configured to vertically actuate runways (16) relative to vertical posts (26) between a lowered position (see FIG. 1A) and a raised position (see FIG. 1B) in order to raise and lower a vehicle supported by runways (16). In the current illustrative example, each actuation assembly (30) includes a hydraulic cylinder (32) operatively coupled to an actuating carriage (38). Each hydraulic cylinder (32) includes a cylinder barrel (34) and a piston rod (36). Cylinder barrels (34) are substantially fixed relative to their respective post (26) via one or more mounting brackets (35). Cylinder barrels (34) are also in hydraulic communication with their respective hydraulic drive unit (200) via hydraulic lines (50). Hydraulic drive units (200) are configured to communicate hydraulic fluid to and from their respective cylinder barrels (34) in order to suitably extend and retract piston rods (36), in a substantially synchronized fashion, relative to their respective cylinder barrel (34). Therefore, all four piston rods (36) are configured to move in a substantial synchronized fashion. Since cylinder barrels (34) are substantially fixed to their respective vertical post (26), piston rods (36) are therefore configured to move relative to vertical post (26) in response to hydraulic fluid entering and exiting cylinder barrels (34) in accordance with the description herein. It should be understood that hydraulic cylinders (32) can include any other suitable structures and features as would be apparent to one skilled in the art in view of the teachings herein.

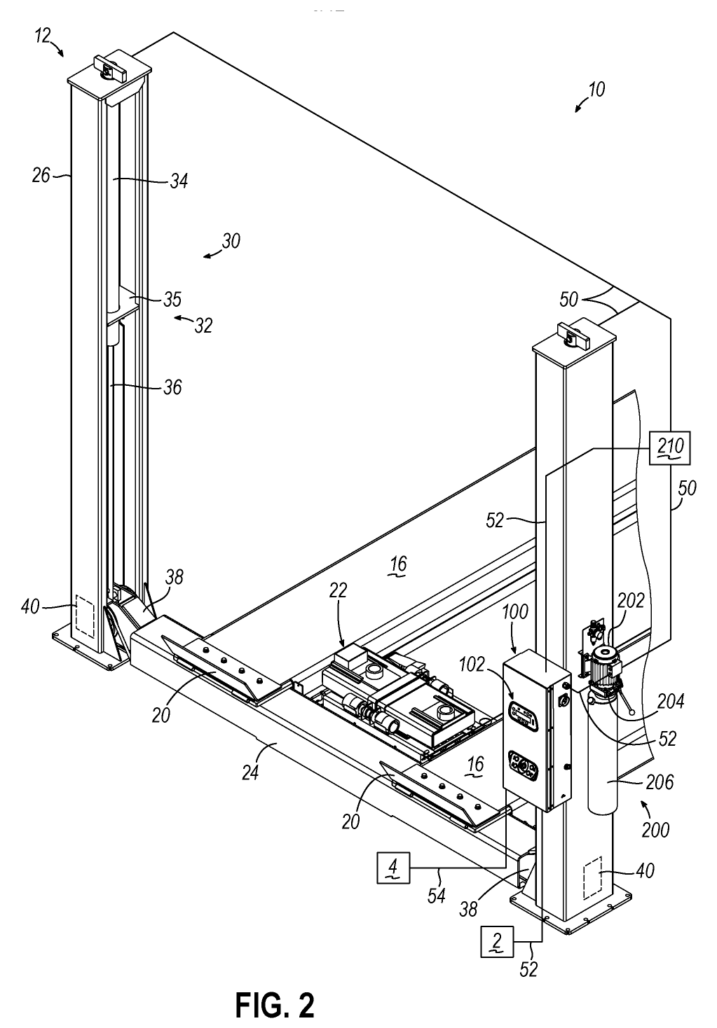

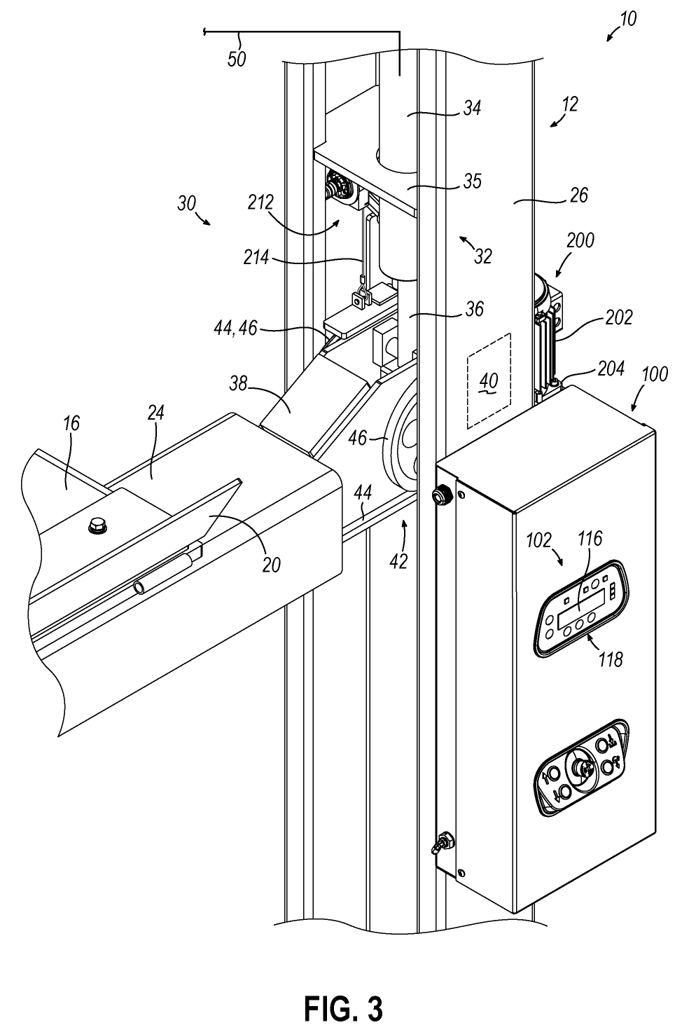

As best shown in FIGS. 2–3, a terminating end of piston rod (36) located opposite cylinder barrel (34) is suitably fixed to a respective actuating carriage (38). Actuating carriages (38) are slidably attached to their respective vertical post (26) such that actuating carriages (38) can move relative to posts (26) along a vertical path. Actuating carriages (38) are also attached to cross-frames (24) such that vertical movement of carriages (38) relative to posts (26) drives vertical movement of their respective cross-frame (24), and therefore runways (16), relative to posts (26). Since piston rods (36) are attached to a respective actuating carriage (38), substantially synchronized movement of piston rods (36) relative vertical posts (26) in accordance with the description herein drives movement of actuating carriages (38) in a substantially synchronized fashion along their predetermined vertical paths relative to posts (26). Since actuating carriages (38) are suitably attached to runways (16), such synchronized movement of actuating carriages (38) also actuates runways (16) relative to posts (26) such that opposite ends of runways (16) rise and lower relative to posts (26) in a substantially level manner. Therefore, actuating assemblies (30) are configured to vertically actuate runways (16) relative to vertical posts (26) between a lowered position (see FIG. 1A), a raised position (see FIG. 1B), and a plurality of positions therebetween.

As mentioned herein, piston rods (36) are configured to extend and retract relative to their respective barrel (34) in order to actuate respective carriages (38), cross-frame (24), and the lifted vehicle along a predetermined vertical path relative to posts (26) between the lowered and raised position. In some instances, due to various factors as would be apparent to one skilled in the art in view of the teachings herein, it may be desirable to allow relative movement (e.g., pivoting and/or tilting) between piston rod (36) and its respective carriage (38) while a vehicle is lifted and lowered in accordance with the description herein.

For example, if the portion of piston rod (36) attached to its respective carriage (38) was statically fixed relative to carriage (38) (i.e., did not accommodate relative movement between piston rod (36) and the portion of carriage (38) directly coupled to piston rod (36)), piston rod (36) may be prone to undesirably bending if the predetermined vertical path which piston rod (36) travels relative to its respective barrel (34) was substantially misaligned (e.g., non-parallel) relative to the predetermined vertical path which carriage (38) actuates along. Additionally or alternatively, if such misalignment were to occur, piston rod (36) may drive carriage (38) into undesirable portions of vertical post (26) as carriage (38) is driven along its predetermined vertical path. This may undesirably increase the frictional braking force between carriage (38) and its respective vertical post (26), which may in turn resist desired movement of carriage (38).

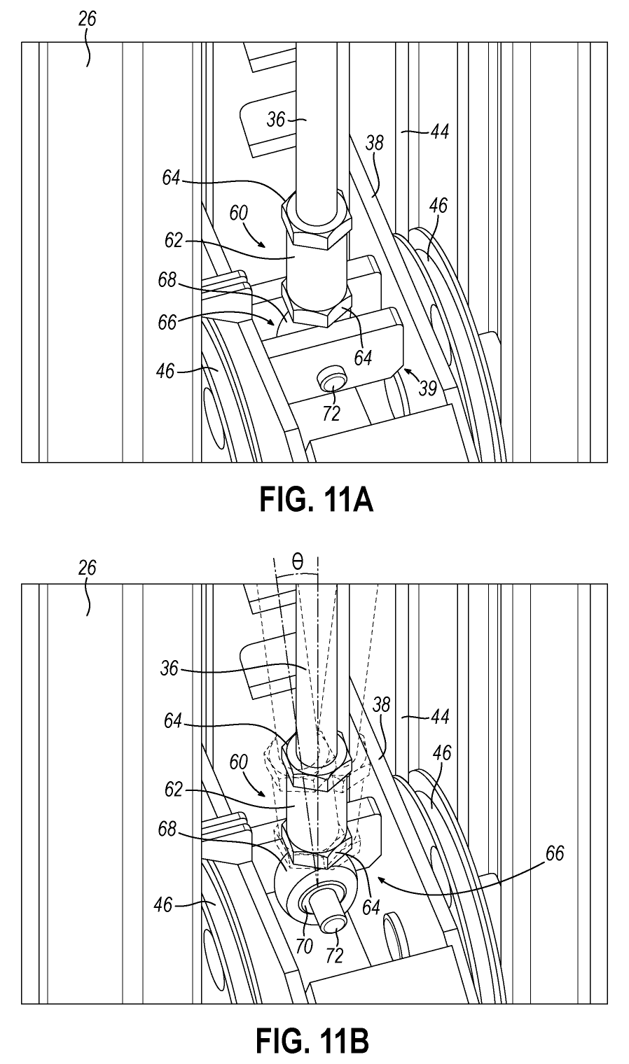

As illustrated in FIGS. 11A–11B, each piston rod (36) is connected to its respective carriage (38) via an illustrative rod-to-yoke connection assembly (60). As will be described in greater detail below, rod-to-yoke connection assembly (60) allows for pivotal movement and/or tilting between piston rod (36) and carriage (38). In instances where piston rod (36) is inadvertently misaligned with the predetermined vertical path of carriage (38), such relative pivotal movement and/or tilting may allow for more forgiveness (e.g., allow carriage (38) to remain aligned with its predetermined vertical path) and may also inhibit bending of piston rod (36) as carriage (38) is actuated along its predetermined path in accordance with the teachings herein.

Rod-to-yoke connection assembly (60) includes a connector (62) in the form of a sleeve, a pair of jam nuts (64) located on opposite ends of connector (62), and a swivel coupling (66). Connector (62) is adjustably attached to a terminating end of piston rod (36). Therefore, during assembly, connector (62) may be longitudinally adjusted relative to piston rod (36) in order to effectively fine-tune the length of piston rod (36) for suitable coupling with its respective carriage (38). Connector (62) may have internal threads configured to suitably mesh with external threading on piston rod (36). Therefore, during assembly, connector (62) may be rotated relative to piston rod (36) in order to adjust the overall length of piston rod (36) and connector (62). Of course, connector (62) may be adjustably coupled to piston rod (36) using any suitable means as would be apparent to one skilled in the art in view of the teachings herein.

A jam nut (64) is located on each end of connector (62). Jam nuts (64) may also be threadably coupled to a suitable portion of piston rod (36). Jam nuts (64) can be utilized to lock the longitudinal position of connector (62) relative to piston rod (36) once a desirable combined length is defined. While jam nuts (64) are used in the current illustrative example, any other suitable locking mechanism to selectively lock the combined length of connector (62) and piston rod (36) may be used as would be apparent to one skilled in the art in view of the teachings herein.

As best shown in FIG. 11B, swivel coupling (66) includes a bushing (68), a bearing (70), and a pin (72) extending through, and coupled to, bearing (70). Bushing (68) is attached to connector (62) such that vertical actuation of connector (62) drives vertical actuation of bushing (68) and, therefore, swivel coupling (66). Bearing (70) is rotatably housed within bushing (68) along multiple axis. As will be described in greater detail below, bearing (70) and bushing (68) enable piston rod (36) to tilt and/or pivot relative to a yoke (39) of carriage (38) along multiple planes up to a maximum tilt angle (θ). In some instances, bearing (70) and bushing (68) may function together substantially similarly to ball and socket swivel bearing. Bushing (68) and bearing (70) may include any suitable structural components as would be apparent to one skilled in the art in view of the teachings herein.

Bushing (68) defines a pair of openings while bearing (70) also defines a pair of openings. Pin (72) is housing within a channel defining by bearing (70) such that pin (72) extends laterally outward from the openings defined by both bushing (68) and bearing (70). Pin (72) is configured to rotate along with bearing (70) relative to bushing (68). In some instances, pin (72) is an integral component of bearing (70) such that bearing (70) does not require defining a pair of openings to accommodate pin (72). As shown in FIG. 11A, pin (72) extends through openings defined by yoke (39) of carriage (38) in order to couple rod-to-yoke connection assembly (60) with carriage (38). Therefore, when assembled, pin (72) is substantially fixed relative to yoke (39) of carriage (38). Engagement between pin (72) and yoke (39) enable piston rod (36) to vertically actuate carriage (38) relative to posts (26) in accordance with the depiction herein.

Since pin (72) and bearing (70) are fixed to yoke (39) of carriage (38) when assembled, and since bearing (70) and pin (72) are configured to rotate within the confines of bushing (68); bushing (68) may suitably rotate relative to carriage (38). Additionally, since bushing (68) and connector (62) are attached to piston rod (36), piston rod (36) may therefore pivot and/or tilt relative to yoke (39) and the remaining portions of carriage (38). Therefore, piston rod (36) can tilt and/or pivot relative to a yoke (39) of carriage (38) along multiple planes up to a maximum tilt angle (θ). In some instances, piston rod (36) may pivot and/or tilt along a lateral plane (e.g., a plane extending in a direction parallel with the length of cross frame (24)) and longitudinal plane (e.g., a plane extending in a direction parallel with the length of runways (16)). In some instances, piston rod (36) may pivot and/or tilt along more planes. For example, in some instances, piston rod (36) may pivot/tilt within a conical path. In some instances, various planes in which piston rod (36) may pivot and/or tilt may have different maximum tilt angles (θ).

Therefore, in instances where the vertical path of piston rod (36) is not substantially aligned with the predetermined vertical path of its respective carriage (38), the relative pivotal movement and/or tilting between piston rod (36) and carriage (38) may allow for more forgiveness (e.g., allow carriage (38) to remain aligned with its predetermined vertical path, thereby reducing an undesirable increase in frictional braking force) and/or may also inhibit bending of piston rod (36) as carriage (38) is actuated along its predetermined path in accordance with the teachings herein

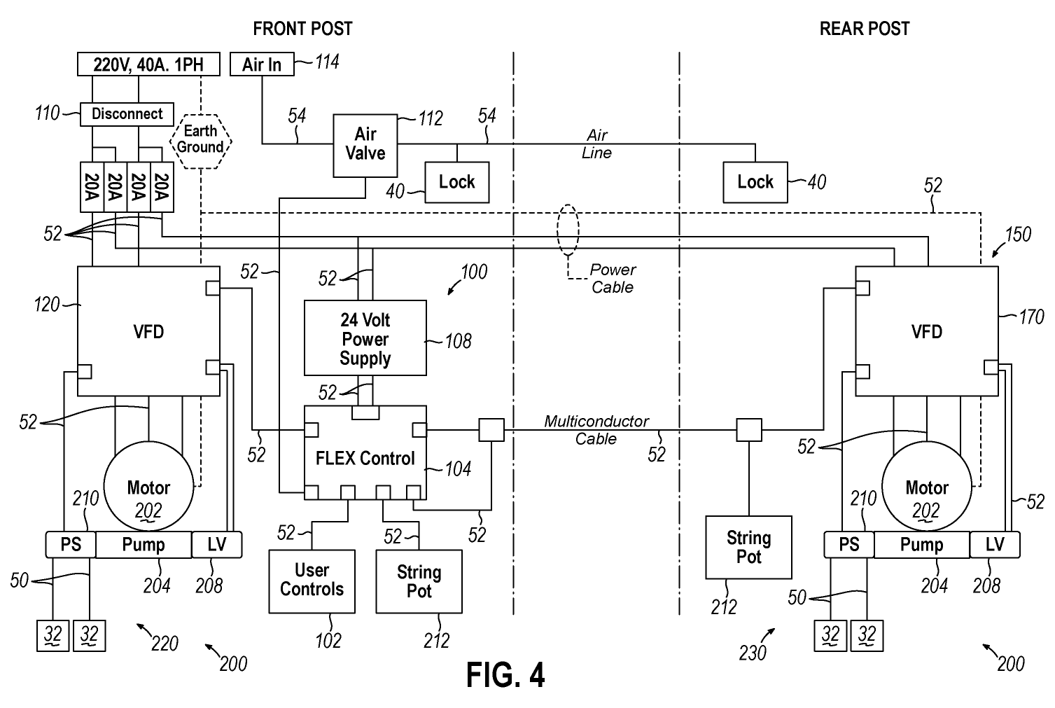

Front lift section (12) and rear lift section (14) each include a string potentiometer (212) (see FIG. 3). String potentiometer (212) is fixed relative to a respective post (26) and also includes a string (214) that is fixed to respective actuating carriage (38). During illustrative use, string potentiometers (212) may measure the height of front lift section (12) and rear lift section (14), respectively, and communicate that measured height to control unit (104) of primary control panel (100) (see FIG. 4). Control unit (104) may compare these two measured heights to confirm runways (16) are elevated in a substantial level manner. If control unit (104) determines that runways (16) are not elevated in a substantially level manner, control unit (104) may generate an error signal, which may then be communicated to suitable components of runway lift (10) to inform a user of the unlevel condition and/or inhibit lift (10) from further elevating. Additionally, or alternatively, if control unit (104) determines that runways (16) are not elevated in a substantially level manner, control unit (104) may instruct one or more suitable variable frequency drives (120, 170) (see FIG. 4) to accelerate/decelerate one end of runways (16) at a faster/slower rate compared to the other end of runways (16) until ends of runways (16) are substantially level.

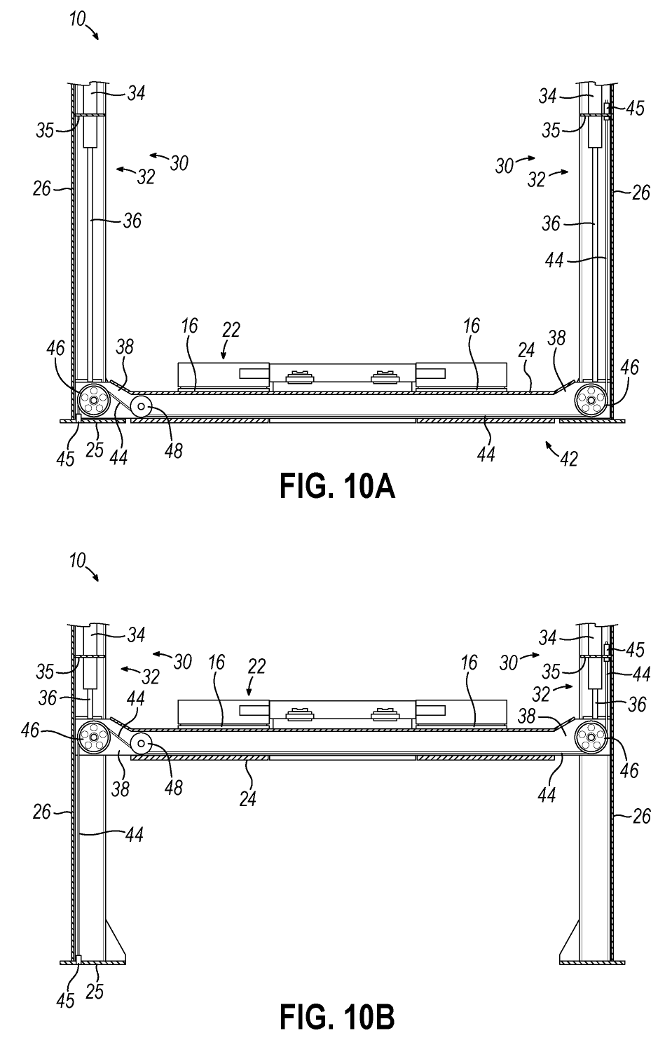

Turning to FIG. 3, the front lift section (12) and the rear lift section (14) may both include a cable equalizing system (42) configured to promote level and synchronized movement of actuating carriages (38) of a respective front lift section (12) or rear lift section (14). As illustrated in FIG. 3, each cable equalizing system (42) includes a pair of cables (44) located on opposing sides of carriages (38). Cable equalizing system (42) includes carriage pulleys (46) located on opposing sides of each carriage (38). Therefore, each cable equalizing system (42) of the current illustrative example includes four carriage pulleys (46). Further, cable equalizing system (42) includes a pair of intermediate pulleys (48) (see FIGS. 10A–10B), which are located on opposing sides of carriages (38) and/or cross-frame (24). One intermediate pulley (48) of the pair is located closer to a first carriage (38), while the other intermediate pulley (48) of the pair is located closer to a second carriage (38). Therefore, while one intermediate pulley (48) is shown closer to the carriage (38) located on the left in FIGS. 10A–10B, it should be understood that the second intermediate pulley (48) of the pair is located on the opposite side of carriages (38) and is located closer to the carriage (38) located on the right in FIGS. 10A–10B. Both cables (44) of a respective cable equalizing system (42) extend laterally through cross-frame (24) and engage with a respective pulley (46) on each carriage (38) as well as a respective intermediate pulley (48).

As shown in FIGS. 10A–10B, each cable (44) has a first terminating end (45) associated with a first vertical post (26), and a second terminating end (45) associated with a second vertical post (26). From the viewpoint shown in FIGS. 10A–10B, the first cable (44) of cable equalizing system (42) has a terminating end (45) suitably attached to mounting bracket (35) on the right vertical post (26). Mounting bracket (35) is fixed relative to its respective vertical post (26). Cable (44) extends downward from mounting bracket (35) located on the right vertical post (26) and wraps at least partially around the right side of the right pulley (46). Further, cable (44) extends away from the bottom of the right pulley (46) through and/or along cross-frame (24) to engage the bottom of intermediate pulley (48). Intermediate pulley (48) directs cable (44) upwards toward the top portion of left pulley (46). Therefore, the portion of cable (44) associated with the left pulley (46) wraps around the top of the left pulley (46). Cable (44) then extends downward from the left side of the left pulley (46) such that the terminating end (45) of cable (44) associated with the left vertical post (26) is suitably attached to a base (25) of the left vertical post (26).

The second cable (44) of cable equalizing system (42) (i.e., the cable (44) on the opposite end of carriage (38) and cross-frame (24) as compared to the cable (44) shown in FIGS. 10A–10B) is arranged conversely to that of the cable (44) shown in FIGS. 10A–10B. Therefore, the terminating end (45) of the second cable (44) that is attached to the right vertical post (26) is attached to the base (25) of the right vertical post (26), while the terminating end (45) of the second cable (44) that is attached to the left vertical post (26) is attached to the mounting bracket (35) of the left vertical post (26).

As shown between FIGS. 10A–10B, as carriages (38) and cross-frame (24) are vertically actuated, cables (44) are fed through their respective pulleys (46, 48) in order to maintain a suitable amount of tension within cable (44). As carriages (38) vertically actuate in accordance with the description herein, the converse arrangement of cables (44) and engagement between pulleys (46,48) and their respective cable (44) help promote vertical alignment between both carriages (38) associated with a particular cable equalizing system (42) (e.g., both carriages (38) associated with front lift section (12)). Therefore, cable equalizing system (42) may assist its respective actuating carriages (38) to remain substantially level with each other in a vertical direction during illustrative use.

Terminating ends (45) may include any suitable structure to attach to a respective post (26) as would be apparent to one skilled in the art in view of the teachings herein. As one example, terminating ends (45) may include a slug that includes suitable attachment features to be affixed to its respective post (26). In some instances, terminating ends (45) may be fixed to their respective post (26) via welding, threaded couplings, jam nuts, and/or any other suitable fixation means as would be apparent to one skilled in the art. In some instances, one terminating end (45) may be fixed to its respective post (26), while the other terminating end may be adjustable relative to its respective post (26) in order to suitably adjust the tension within cable (44). Of course, in some instances, each terminating end (45) may be adjustable relative to its respective post (26).

Additionally, actuating carriages (38) can include any suitable structure as would be apparent to one skilled in the art in view of the teachings herein. In the current example, each actuating carriage (38) includes a mechanical lock (40). Each vertical post (26) can include complementary features configured to selectively engage the mechanical lock (40) during illustrative use in accordance with the description herein. Therefore, the mechanical lock (40) can selectively engage such complementary features of the post (26) while the runways (16) are elevated relative to the shop floor to thereby support runways (16) in an elevated position (e.g., the raised position shown in FIG. 1B). Once runways (16) are elevated to a desired position, such mechanical locks (40) can primarily support the elevated runways (16) instead of hydraulic cylinders (32) of actuation assemblies (30). Mechanical locks (40) may include any suitable structures and features as would be apparent to one skilled in the art in view of the teachings herein.

When a technician desires to lower runways (16), the technician can selectively disengage the mechanical locks (40) from the complementary features of the posts (26), thereby allowing actuation assemblies (30) to lower runways (16) in accordance with the description herein. In the current example, mechanical locks (40) are powered by a source of compressed air (4) (see FIGS. 1A–2), which may couple to an air supply coupling (114) (see FIG. 4) via an air hose (54). An air valve (112) (see FIG. 4) may be configured to selectively communicate air to mechanical locks (40) to drive mechanical locks (40) out of engagement with complementary features of post (26), thereby allowing actuation assemblies (30) to lower runways (16) in accordance with the description herein. As shown in FIG. 4, air valve (112) is in electrical communication with a control circuit (104) via electrical communication lines (52). Control circuit (104) is in electrical communication with user controls (102). A technician may utilize user controls (102) to instruct control circuit (104) and air valve (112) to drive mechanical locks (40) to disengage from their respective complementary features of their respective post (26), thereby allowing runways (16) to be lowered via actuation assembly (30) in accordance with the description herein.

As mentioned above, control panel (100) and hydraulic drive unit (200) associated with front lift section (12) are configured to drive movement of actuation assemblies (30) associated with front lift section (12); while control panels (100, 150) and hydraulic drive unit (200) associated with rear lift section (14) are configured to simultaneously drive movement of actuation assemblies (30) associated with rear lift section (14). As shown in FIGS. 1A–1B, primary control panel (100) is fixed relative to a respective post (26) and is configured to couple to a power source (2). As shown in FIG. 4, primary control panel (100) may couple with a suitable power source (2) via power coupling (110). Primary control panel (100) is also in electrical communication with secondary control panel (150) and hydraulic drive unit (200) of front lift section (12) via suitable electrical communication lines (52); while secondary control panel (150) is also in electrical communication with hydraulic drive unit (200) of rear lift section (14) via suitable electrical communication lines (52). Primary control panel (100) may receive user input via a user controls (102) to thereby (A) instruct hydraulic drive unit (200) of front lift section (12) to raise and/or lower its respective actuation assemblies (30), and (B) instruct secondary control panel (150) and hydraulic drive unit (200) of rear lift section (12) to simultaneously raise and/or lower its respective actuation assemblies (30).

Primary control panel (100) includes user controls (102), a control unit such a FLEX control circuit (104), a power supply (108) such as a 24-volt power supply, a power coupling (110), an air valve (112), and a variable frequency drive “VFD” (120). Secondary control panel (150) includes a second variable frequency drive (170). As shown in FIG. 4, user controls (102) are in electrical communication with control unit (104) via electrical communication line (52). Such communication may be bi-directional such that control unit (104) may communicate information to user controls (102); while user controls (102) may communicate information to control unit (104).

User controls (102) allow a technician to input suitable commands to operate lift (10), as well as view suitable information from lift (10). As shown in FIG. 3, user controls (102) include at least one visual display (116) and at least one input feature (118). Visual display (116) can display suitable information to a user, such as relevant information during illustrative use of lift (10) in accordance with the description herein. For instance, visual display (116) may display information provided by control unit (104) (e.g., information associated with operation of lift (10)), warning signals generated by lift (10), information generated by input from a user into user controls (102), or any other suitable information as would be apparent to one skilled in the art in view of the teachings herein. Visual display (116) may include any suitable structures/feature as would be apparent to one skilled in the art in view of the teachings herein. For example, visual display (116) may include LED lights, numerical display tubes, LCD screens, touch screens, avatars representing specific features of lift (10), etc.

User input features (118) allow a user to input suitable information into lift (10), which is then communicated to control unit (104); which can utilize the input information to control lift (10). For example, a user may utilize the at least one input feature (118) to generate lifting commands (e.g., actuate runways (16) upwards/downwards), generate lifting speed commands, generate lowering speed commands, activate/deactivate locking mechanisms (40) in accordance with the description herein, etc. User input feature (118) may include buttons, one or more touch screens, joy-sticks, emergency stop buttons configured to immediately cease operation of lift (10), etc.

As shown at least in FIG. 4, control unit (104) is in electrical communication with user controls (102), power supply (108), air valve (112), variable frequency drive (120), another variable frequency drive (170) of secondary control panel (150), and string potentiometers (212).

Control unit (104) is configured to receive information/data from various sources, process the received information/data, and generate suitable instructions/signals in response to the processed information/data. Control unit (104) may include any suitable structures as would be apparent to one skilled in the art in view of the teachings herein. For example, control unit (104) may include a FLEX control circuit, another suitable control circuit, a processor, memory, a hard drive, etc.

As mentioned above, control unit (104) is configured to activate air valve (112) in order to suitably control locking mechanism (40) in accordance with the description herein. As also mentioned above, control unit (104) is configured to work in conjunction with user controls (102) to enable a technician to suitable control lift (10) in accordance with the description herein. Control unit (104) is also in communication with variable frequency drives (120, 170) such that control unit (104) may activate variables frequency drives (120, 170), receive suitable data from variable frequency drives (120, 170), adjust performance of variable frequency drives (120, 170), etc. As will be described in greater detail below, control unit (104) is also in communication with suitable components forming a front lift section loading gauge (220) and a rear lift section loading gauge (230) such that control unit (104) may utilize information from suitable components of loading gauges (220, 230) to determine if either front lift section (12) or rear lift section (14) is overloaded while lifting and/or supporting a vehicle supported by runways (16).

Twenty-four-volt power supply (108) is configured to receive power from power source (2) (see FIGS. 1A–1B) via power coupling (110) and thereby power suitable components of lift (10). As shown in FIG. 4, power supply (108) is in electrical communication with control unit (104). Therefore, power supply (108) may electrically power control unit (104). Control unit (104) may be further configured to distribute electrical power from power supply (108) to other suitable components, such as string potentiometer (212), user controls (102), and suitable components of loading gauges (220, 230). Some components of lift (10), such as variable frequency drives (120, 170), may be electrically powered by features of power coupling (110) rather than 24-volt power supply (108).

Each variable frequency drive (120, 170) is in electrical communication with a respective motor (202) of hydraulic drive unit (200). Variable frequency drives (120, 170) are configured to suitably power motors (202) in order to pump hydraulic fluid into respective hydraulic cylinders (32) to suitably lift runways (16) in accordance with the description herein. Variable frequency drive (120, 170) may alter the amount of power provided to its respective motor (202) in order to control the lifting speed at which runways (16) are vertically actuated.

Variable frequency drives (120, 170) are configured to measure the electrical load required for its respective motor (202) to pump hydraulic fluid at a known volumetric flow rate to thereby suitably lift runways (16) at a default lifting speed in accordance with the description herein. For example, a hydraulic pump (e.g., pump (204)) with a fixed displacement (e.g., 4.3 cubic centimeters per revolution) may be coupled to a motor (e.g., motor (202)) with a default lifting speed of 1800 revolutions per minute when configured to run at 60Hz input power by VFD (120, 170). VFD (120, 170) can measure amperage to estimate the electrical load on the system. The components of the electrical load will be the distributed weight of the vehicle supported by the hydraulic cylinders on one end of the lift, the weight of the runways and lift components supported by the hydraulic cylinders on one end of the lift, and the losses due to efficiency of the hydraulic, mechanical, and electrical system. In a well-characterized system running at default lifting speed, the weight of the lift components and efficiency losses can be accounted for and deducted such that the weight of the vehicle supported by the hydraulic cylinders on one end of the lift can be estimated based on using amperage as the electrical load. Such an electrical load may be referred to as a default lifting speed measured load. Of course, the default lifting speed measured load may be determined using any other suitable means as would be apparent to one skilled in the art in view of the teachings herein.

Variable frequency drives (120, 170) may communicate this electrical load to control unit (104), which may then utilize the default lifting speed measured load in order to determine the weight being supported by the respective front lift section (12) and rear lift section (14). As an example, control unit (104) may utilize the default lifting speed measured load in a suitable formula to calculate the supported weight of the respective front lift section (12) and rear lift section (14). As another example, control unit (104) may utilize a lookup table where a list of possible default lifting speed measured loads are associated with a corresponding list of supported weights. Control unit (104) may compare the default lifting speed measured load taken during illustrative use against the list of possible default lifting speed measured loads in order to determine the supported weight of the respective front lift section (12) and rear lift section (14) during illustrative use.

It should be understood that in some instances, the load of a lifted vehicle may not be evenly distributed between the front lift section (12) and rear lift section (14). In such instances, variable frequency drive (120) of front lift section (12) may measure a first default lifting speed measured load; while variable frequency drive (170) may simultaneously measure a second default lifting speed measured load. Therefore, control unit (104) may utilize information obtained from variable frequency drives (120, 170) in order to determine the weight distribution on the front lift section (12) as compared to the rear lift section (14) during illustrative use in accordance with the description herein.

Variable frequency drives (120, 170) may include any suitable structures/features as would be apparent to one skilled in the art in view of the teachings herein. For example, variable frequency drives (120, 170) may incorporate the teachings of U.S. Patent No. 12,195,313, entitled “Load-Sensing Vehicle Lift,” issued on January 14, 2025, which is incorporated by reference herein.

Each hydraulic drive unit (200) includes a motor (202), a pump (204), and a reservoir (206) of hydraulic fluid. Motor (202), pump (204), and reservoir (206) are fixed relative to a respective post (26). As mentioned above, motor (202) is in electrical communication with its respective variable frequency drive (120, 170) such that variable frequency drive (120, 170) may suitably activate its respective motor (202) in accordance with the description herein.

Pump (204) of front lift section (12) is in fluid communication with the two hydraulic cylinders (32) of front lift section (12); while pump (204) of rear lift section (14) is in fluid communication with the two hydraulic cylinders (32) of rear lift section (14). Motor (202) is configured to activate pump (204) in accordance with the description herein to thereby drive hydraulic fluid from reservoir (206) toward its respective hydraulic cylinders (32) to thereby raise runways (16) in accordance with the description herein. During illustrative use, a user may utilize user controls (102) to instruct lift (10) to raise runways (16). Such a command may be communicated to control unit (104), which may then instruct variable frequency drives (120, 170) to activate their respective motor (202) and pump, which in turn lifts runways (16) in accordance with the description herein.

While two hydraulic drive units (200) and two variable frequency drives (120, 170) are used in the current example, it should be understood that runway lift (10) may include any suitable combination of hydraulic drive units (200) and VFDs as would be apparent to one skilled in the art in view of the teachings herein. For example, in some instances, a single hydraulic drive unit (200) may be used to drive all hydraulic cylinders (32). As another example, four hydraulic drive units (200) may be utilized, one for each hydraulic cylinder (32).

As shown in FIG. 4, each hydraulic drive unit (200) includes a lowering valve (208). Lowering valve (208) is configured to limit the volumetric flow rate at which hydraulic fluid exits hydraulic cylinders (32) and enters reservoir (206). When runways (16) are lowered in accordance with the description herein, lowering valves (208) are configured to limit the speed at which runways (16) are lowered due to the limited flow rate of hydraulic fluid exiting hydraulic cylinders (32).

B. Illustrative Front and Rear lift section Loading Gauge for Runway Lift

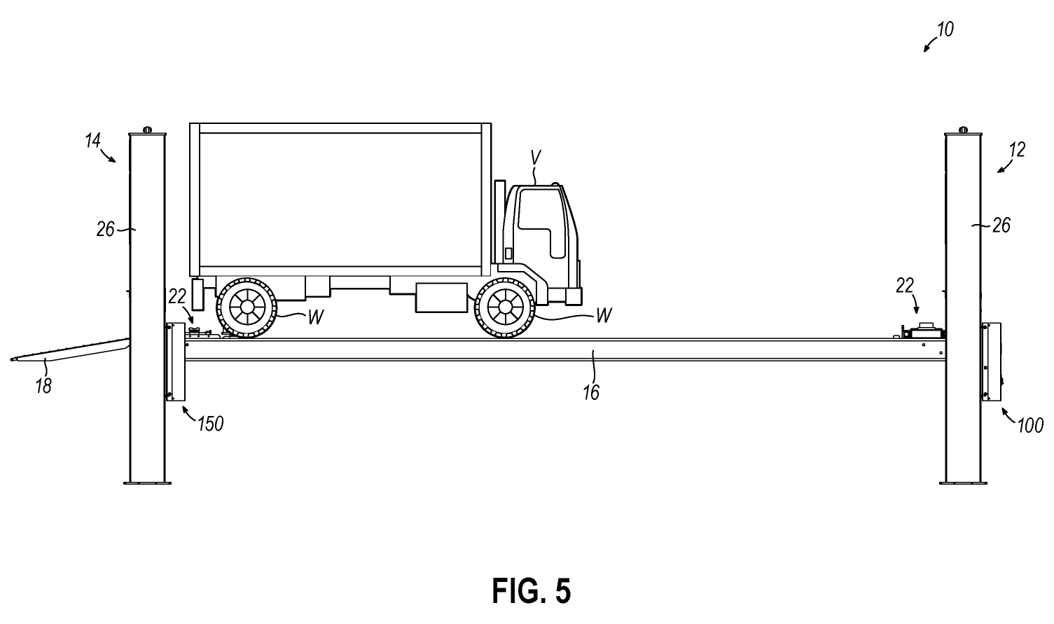

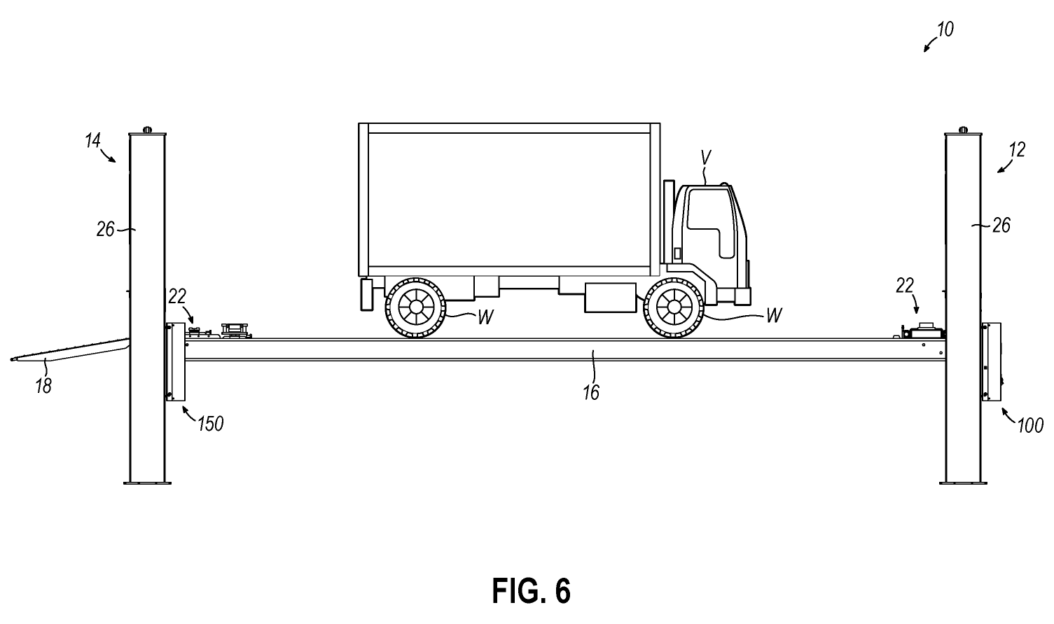

As mentioned above, during illustrative use of lift (10), while runways (16) are in the lowered position (see FIG. 1A), a vehicle to be lifted is driven/rolled onto runways (16) and then subsequently lifted via front lift section (12) and rear lift section (14). In some instances, the vehicle to be lifted has a wheelbase that is substantially shorter than the length of runways (16). An example of such an instance is shown in FIGS. 5 and 6, where a lifted vehicle (V) has wheels (W) with a wheelbase around half the length of runways (16).

In such instances, as shown in FIG. 6, a user may drive/roll vehicle (V) onto runways (16) a suitable distance such that the center of gravity of such a vehicle is positioned substantially equal distances between front lift section (12) and rear lift section (14). In such instances, the weight distribution between front lift section (12) and rear lift section (14) may be substantially equal and/or within an acceptable tolerance such that neither front lift section (12) nor rear lift section (14) are overloaded (e.g., supporting more weight than intended). However, in some instances, as shown in FIG. 5, a user may drive/roll vehicle (V) onto runways (16) such that the center of gravity of vehicle (V) is substantially closer to one section (12, 14) of the lift (10) as compared to the opposite section (12, 14). In such instances, one section (12, 14) may be supporting a majority of the vehicle’s (V) weight while lifted on runways (16). In some instances, such a vehicle (V) may have a total weight that is acceptable to be lifted by lift (10) when properly loaded onto runway (16) (e.g., substantially centered as shown in FIG. 6), but is not acceptable to be lifted by lift (10) when overloaded on one section (12, 14) as compared to the other section (12, 14) (e.g., as shown in FIG. 5).

Therefore, it may be desirable to monitor the load which a vehicle (V) imparts on each individual section (12, 14) in order to determine if an individual section (12, 14) is overloaded compared to its acceptable lifting capacity. Further, it may be desirable to notify a user of such overloading and/or inhibit raising the vehicle (V) to its desired elevation for maintenance/inspection.

As mentioned above, runway lift (10) includes a front lift section loading gauge (220) and a rear lift section loading gauge (230). Front loading gauge (220) is configured to measure parameter(s) associated with the weight of a vehicle being supported by front lift section (12); while rear loading gauge (230) is configured to measure parameter(s) associated with the weight of a vehicle supported by rear lift section (14) of lift (10). Further, gauges (220, 230) are configured to communicate such measured parameter(s) to control unit (104) such that control unit (104) may utilize the measured parameter(s) to determine if either front lift section (12) or rear lift section (14) is overloaded while lifting a vehicle in accordance with the description herein.

In the current example, as shown in FIGS. 1A–1B and 4, front lift section loading gauge (220) includes a pressure sensor (210) interposed between hydraulic drive unit (200) of front lift section (12) and at least one hydraulic cylinder (32) of front lift section (12). Additionally, rear lift section loading gauge (230) includes a pressure sensor (210) interposed between hydraulic drive unit (200) of rear lift section (14) and at least one hydraulic cylinder (32) of rear lift section (14). Pressure sensors (210) are configured to measure the pressure within their respective hydraulic circuit between at least one hydraulic cylinder (32) and pump (204).

When runways (16) are supporting a vehicle and elevated away from the lowered position, and mechanical locks (40) are disengaged from the complementary features on their respective post (26), the hydraulic cylinders (32) and hydraulic drive units (200) are supporting the load of the vehicle on runways (16). The hydraulic cylinder piston (36) will have fixed cross-sectional area exposed to pressurized hydraulic fluid. The amount of pressure in the hydraulic system will be mostly composed of the weight of the vehicle supported by the hydraulic cylinders on one end of the lift, and the weight of the runways and lift components supported by the hydraulic cylinders (32) on one end of the lift. In a well-characterized system, the weight of the lift components can be accounted for and deducted such that the weight of the vehicle supported by the hydraulic cylinders on one end of the lift (10) can then be estimated based on using measured hydraulic pressure while lift (10) supports a vehicle.

Therefore, the pressure measured by each hydraulic sensor (210) may be indicative of the weight being supported by the section (12, 14) which each hydraulic sensor (210) associates with. Pressure sensors (210) are in electrical communication with their respective variable frequency drive (120, 170). Therefore, data obtained by pressure sensors (210) during illustrative use may be communicated to their respective variable frequency drive (120, 170), which may in turn communicate such data to control unit (104). In some instances, pressure sensors (210) may be in direct communication with control unit (104).

Control unit (104) may utilize the pressure data received from each pressure sensor (210) in order to determine the load being supported by each of the front lift section (12) and rear lift section (14), respectively. In other words, control unit (104) may utilize the pressure data obtained from each pressure sensor (210) to determine the weight being supported by hydraulic cylinders (32) and hydraulic drive unit (200) of the front lift section (12), as well as the weight being supported by the hydraulic cylinders (32) and hydraulic drive unit (200) of the rear lift section (14). As will be described in greater detail below, control unit (104) may utilize this data to determine if either front lift section (12) or rear lift section (14) are overloaded (e.g., supporting a weight that is above a predetermined threshold), and generate some type of signal in response to detecting such an overloaded condition.

In the current examples, front lift section loading gauge (220) also includes variable frequency drive (120); while rear lift section loading gauge (230) also includes second variable frequency drive (170). As mentioned above, variable frequency drives (120, 170) are configured to measure the electrical load required for its respective motor (202) to pump hydraulic fluid at a known volumetric flow rate to thereby suitably lift runways (16) at a default lifting speed in accordance with the description herein. As also mentioned above, variable frequency drives (120, 170) may communicate this measured parameter to control unit (104) such that control unit (104) can determine the weight being supported by the front lift section (12) (based on the measured parameter of variable frequency drive (120)) and the weight being supported by rear lift section (14) (based on the measured parameter of variable frequency drive (170)). As will be described in greater detail below, control unit (104) may utilize this data to determine if either front lift section (12) or rear lift section (14) are overloaded (e.g., supporting a weight that is above a predetermined threshold), and generate some type of signal in response to detecting such an overloaded condition.

It should be understood that loading gauges (220, 230) include both pressure sensors (210) and a respective variable frequency drive (120, 170); either of which can determine the load being supported by front and rear lift sections (12, 14). Therefore, in some instances, load gauges (220, 230) may include just the use of pressure sensor (210), just the use of variable frequency drives (120, 170), the use of one pressure sensor (210) and one variable frequency drive (120, 170), or any other suitable combination of pressure sensors (210) and variable frequency drives (120, 170) as would be apparent to one skilled in the art in view of the teachings herein. Additionally, while pressure sensors (210) and variable frequency drives (120, 170) are described in the current illustrative examples as determining the load which front and rear lift sections (12, 14) individually support while lifting a vehicle in accordance with the description herein, any other suitable structures to determine the load which front and rear lift sections (12, 14) support may be used as would be apparent to one skilled in the art in view of the teachings herein. For example, load cells may be placed between cross-frame (24) and ends of runways (16) in order to measure a load being supported by either front or rear lift section (12, 14).

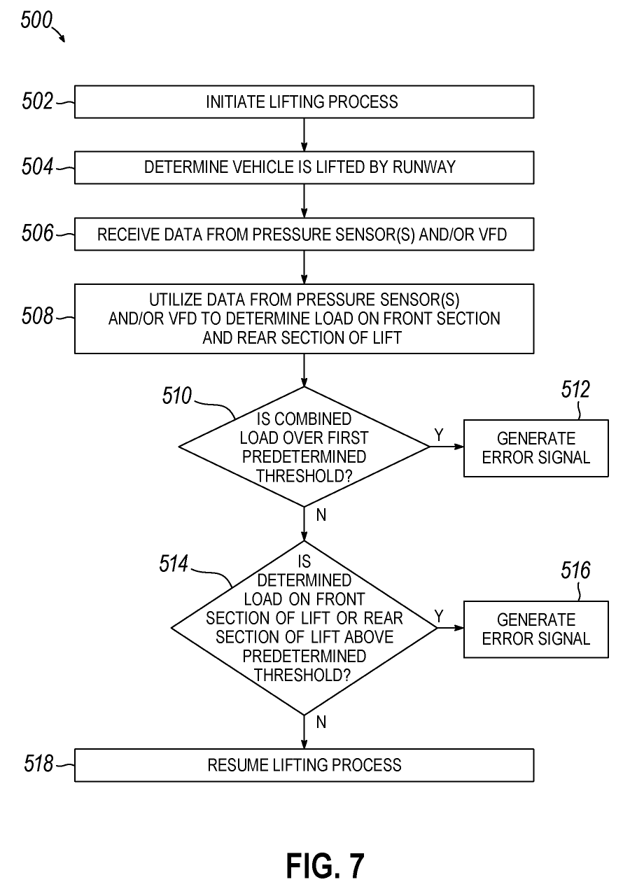

FIG. 7 shows an illustrative method (500) of control unit (104) using measured parameter(s) from front lift section loading gauge (220) and rear lift section loading gauge (230) while lifting a vehicle with runway lift (10). Prior to starting method (500), lift (10) may be in the lowered position similar to that shown in FIG. 1A. With lift (10) in the lowered position, users may drive/roll a vehicle onto runway (16) in accordance with the description herein. Once a vehicle is supported on runways (16), a user may then instruct lift (10) via user controls (102) to initially lift runways (16) and vehicle upwards. In response, control unit (104) initiates the lifting process (502).

With the lifting process initiated (502), runways (16) may start to elevate upwards along the predetermined path defined by posts (26) in accordance with the description herein. Therefore, control unit (104) instructs variable frequency drive (120, 170) to activate their respective motors (202) to pump hydraulic fluid toward hydraulic cylinders (32) in accordance with the description herein to lift runways (16).

Next, control unit (104) determines (504) that vehicle is being lifted and supported by runway (16) and the four actuation assemblies (30) in accordance with the description herein. In other words, control unit (104) determines that runway (16) is sufficiently elevated off of the shop floor such that lifting forces generated by hydraulic cylinders (32) and hydraulic drive units (200) are primarily lifting the vehicle off the shop floor.

Control unit (104) may make this determination (504) using any suitable means as would be apparent to one skilled in the art in view of the teachings herein. For example, control unit (104) may use data provided by string potentiometers (212) to determine (504) that the vehicle is sufficiently lifted off of the shop floor and being supported by hydraulic drive units (200). As another example, control unit (104) may use data from variable frequency drives (120, 170) to determine that the vehicle is being supported by hydraulic drive units (200). For instance, the measured load from variable frequency drives (120, 170) may begin to level off once runways (16) are sufficiently elevated from shop floor such that hydraulic drive units (200) are primarily lifting vehicle and runways (16) off the shop floor. This leveling off may indicate to control unit (104) that the vehicle is suitably lifted off of the shop floor. As another example, control unit (104) may use data from pressure sensors (210) to determine that the vehicle is being supported by hydraulic drive units (200). For instance, the change in measured pressure over time may begin to level off once runways are sufficiently elevated from shop floor such that hydraulic drive units (200) are primarily lifting vehicle and runways (16). This leveling off may indicate to control unit (104) that the vehicle is suitably lifted off of the shop floor.

After control unit (104) determines (504) that the lifted vehicle and runways (16) are suitably lifted off the shop floor, the control unit (104) receives (506) suitable data from pressure sensors (210) and/or the variable frequency drives (120, 170) indicative of the load being supported by front lift section (12) and the load being supported by rear lift section (14). Of course, while data from pressure sensor (210) and/or variable frequency drives (120, 170) is contemplated in the current method (500), other suitable sources of data indicative of the load being supported by sections (12, 14) may be used as well (e.g., load cell data, etc.).

Next, control unit (104) utilizes the received data (508) to determine the loads being supported by the front lift section (12) and the load being supported by the rear lift section (14). Control unit (104) may determine the loads being supported by front lift section (12) and rear lift section (14) in accordance with the teachings herein. The control unit (104) may utilize the determined loads in order to display suitable information on visual display (116) as would be apparent to one skilled in the art in view of the teachings herein. For example, control unit (104) may instruct visual display (116) to display the calculated loads being supported by both front lift section (12) and rear lift section (14) in real time. In some instances, control unit (104) may utilize visual display (116) to continuously display the calculated loads being supported by both front lift section (12) and rear lift section (14) during illustrative use of lift (10) in accordance with the description herein. As another example, control unit (104) may instruct visual display (116) to display the magnitude of the total load or the amount at which the lift (10) is overloaded. As yet another example, control unit (104) may instruct visual display (116) to display the ratio of loads at one lift section (12,14) versus the other lift section (12, 14).

Next, control unit (104) determines (510) if the combined load supported by both the front lift section and rear lift section (14) is over a predetermined threshold value. If the combined load is over the predetermined threshold value, this may be indicative that the vehicle being lifted is too heavy for the particular runway lift (10) being utilized. In such instances, control unit (104) generates (512) an error signal. Such an error signal may be any suitable signal as would be apparent to one skilled in the art in view of the teachings herein. For example, such an error signal may communicate to visual display (116) to let the user know that the lift (10) as a whole is overloaded. As another example, such an error signal may inhibit control unit (104) from further elevating runways (16) upwards and only allow control unit (104) to lower runways (16) back to the lowered position. As mentioned above, as another example, control unit (104) may instruct visual display (116) to display the magnitude at which the lift (10) is being overloaded as compared to the lifts (10) predetermined max lifting capacity.

If the combined load is not over the predetermined threshold value, the control unit (104) then determines (514) if the load associated with front lift section (12) or the load associated with rear lift section (14) is above its respective predetermined threshold value. If either load associated with sections (12, 14) is above its respective predetermined threshold value, this may be indicative that the vehicle being lifted is overloaded on one section (12, 14) compared to the other. In such instances, control unit (104) generates (516) and error signal. Such an error signal may be any suitable signal as would be apparent to one skilled in the art in view of the teachings herein. For example, such an error signal may communicate to visual display (116) to let the user know that one section of lift (10) is overloaded. As another example, such an error signal may inhibit control unit (104) from further elevating runways (16) upwards and only allow control unit (104) to lower runways (16) back to the lowered position. In some instances, control unit (104) utilizes the error signal to disable user controls (102) from being utilized to further elevate runways (16) upwards yet allows user controls (102) to be utilized to lower runways (16) back to the lowered position. As another example, such an error signal may generate user instructions to instruct a user to lower lift (10) and reposition vehicle. As another example, control unit (104) may instruct visual display (116) to display the ratio of loads at one lift section (12,14) versus the other lift section (12, 14), with an indication that the ratio is imbalanced and/or an indication at which side the overloaded imbalance is occurring.

However, if neither load associated with section (12, 14) is above its respective predetermined threshold value, control unit (104) may resume (518) the lifting process. In some instances, control unit (104) may generate an instruction indicating to a user that the vehicle being lifted is under the predetermined threshold and/or suitably balanced between lift sections (12, 14). It should be understood that the predetermined threshold value for the front lift section (12) and the rear lift section (14) may be the same value, or may be different values, depending on the characteristics of runway lift (10). For instance, in some lifts, the front lift section (12) may be configured to accommodate a heavier load as compared to the rear lift section (14). Naturally, the front lift section (12) in such cases would have a higher predetermined threshold value and compared to the rear lift section (14).

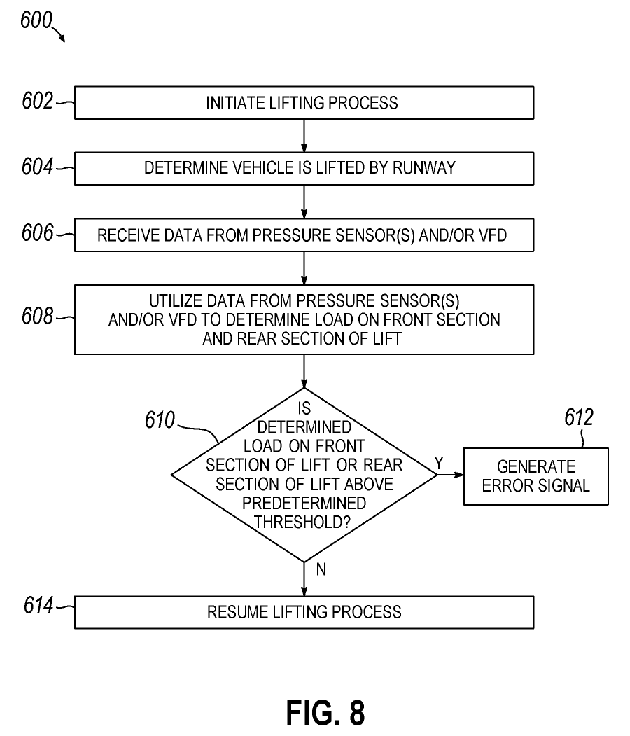

In some instances, it may not be necessary to perform the additional step of determining if the combined load of the front and rear lift section (12, 14) is under a predetermined threshold value. In such instances, determining if individual loads of the front and rear lift section (12, 14) are above their respective predetermined threshold values may be sufficient. FIG. 8 shows an illustrative method (600) covering such a concept.

FIG. 8 shows an illustrative method (600) of control unit (104) using measured parameter(s) from front lift section loading gauge (220) and rear lift section loading gauge (230) while lifting a vehicle with runway lift (10). Method (600) is substantially similar to method (500) described above, except method (600) omits the step (510) of determining if the combined load of the front lift section (12) and the rear lift section (14) is under a predetermined threshold value. Therefore steps (602, 604, 606, 608) are substantially similar to steps (502, 504, 506, 508) of method (500). Additionally, steps (610, 612, 614) are substantially similar to steps (514, 516, 518) described above, except that the step (510) of determining if the combined load of the front lift section (12) and the rear lift section (14) are under a predetermined threshold value is omitted.

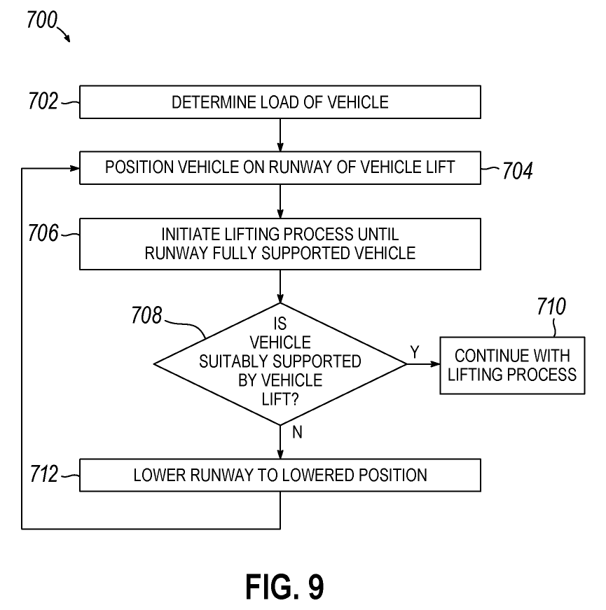

FIG. 9 shows an illustrative method (700) of a user using runway lift (10) to lift a vehicle. First, the user may determine (702) the load of the vehicle (702) to ensure that lift (10) is rated to lift such a vehicle. If the vehicle has a weight that is sufficient for lift (10) to raise vehicle, next, the user may position (704) vehicle on runways (16). After suitable positioning vehicle on runways (16), the user may initiate (706) the lifting process in accordance with the description herein. Next, the user may determine (708) if the vehicle is suitably supported by the vehicle lift (10). Such a determination may be made based on whether lift (10) generates an error signal in accordance with methods (500, 600) described above. If it is determined that vehicle is suitably supported, the user may continue (710) with the lifting process. However, if it is determined that the vehicle is not suitable supported, a user may lower (712) runways (16) to the lowered position and reposition (704) the vehicle on runways to a more centered location and re-initiate the lifting process (706) in accordance with the description herein.

### II. Illustrative Combinations

The following non-exhaustive examples relate to various ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to be critical or to have been added for any reason relating to patentability.

### Example 1

A runway lift, comprising: (a) a front lift; (b) a rear lift; (c) a pair of runways extending between the front lift and the rear lift, wherein the front lift and the rear lift are configured to actuate the pair of runways between a lowered position and a raised position; (d) a front lift loading gauge configured to measure a front load data on the front lift as the pair of runways moves away from the lowered position toward the raised position; (e) a rear lift loading gauge configured to measure a rear load data on the rear lift as the pair of runways moves away from the lowered position toward the raised position; and (f) a control unit in communication with both the front lift loading gauge and the rear lift loading gauge, wherein the control unit is configured to receive the front load data and the rear load data, wherein the control unit is configured to determine if the front lift is overloaded using the front load data, wherein the control unit is configured to determine if the rear lift is overloaded using the rear load data, and wherein the control unit is configured to generate a signal in response to determining if the front lift is overloaded or if the rear load is overloaded.

### Example 2

The runway lift of Example 1, wherein the control unit is configured to utilize the front load data to calculate a front load value

### Example 3

The runway lift of Example 2, wherein the control unit is configured to utilize the rear load data to calculate a rear load value.

### Example 4

The runway lift of Example 3, wherein the control unit stores a front lift predetermined threshold value and a rear lift predetermined threshold value, and wherein the control unit is configured to compare the front lift predetermined threshold value against the front load value to determine if the front lift is overloaded.

### Example 5

The runway lift Example 4, wherein the control unit is configured to compare the rear lift predetermined threshold value against the rear load value to determine if the rear lift is overloaded.

### Example 6

The runway lift of any one or more of the preceding Examples, wherein the control unit is configured to calculate of total load supported by the runway lift as the pair of runways moves from the lowered position toward the raised position.

### Example 7

The runway lift of Example 6, wherein the control unit stores a total load predetermined threshold value, and wherein the control unit is configured to compare the total load predetermined threshold value against the total load to determine whether the runway lift is overloaded.

### Example 8

The runway lift of any one or more of the preceding Examples, wherein the front lift comprises a front lift section, wherein the front lift section comprises a first pair of posts, wherein the rear lift comprises a rear lift section, and wherein the rear lift section comprises a second pair of posts.

### Example 9

The runway lift of Example 8, wherein the first pair of posts comprises a first cable equalizing system, and wherein the second pair of posts comprises a second cable equalizing system.

### Example 10

The runway lift of Example 8 or 9, wherein the first pair of posts comprises a first string potentiometer, and wherein the second pair of posts comprises a second string potentiometer.

### Example 11

The runway lift of any one or more of the preceding Examples, wherein the front lift comprises a first pair of hydraulic cylinders, and wherein the rear lift comprises a second pair of hydraulic cylinders.

### Example 12

The runway lift of Example 11, wherein the front lift comprises a first hydraulic drive configured to power the first pair of hydraulic cylinders, wherein the rear lift comprises a second hydraulic drive configured to power the second pair of hydraulic cylinders, wherein the first hydraulic drive comprises a first motor and a first pump, and wherein the second hydraulic drive comprises a second motor and a second pump.

### Example 13

The runway lift of Example 12, wherein the front lift loading gauge comprises a first pressure sensor configured to measure a pressure value within the first pair of hydraulic cylinders, wherein the rear lift loading gauge comprises a second pressure sensor configured to measure a pressure value within the second pair of hydraulic cylinders.

### Example 14

The runway lift of Example 12, wherein the first hydraulic drive further comprises a first variable frequency drive, wherein the second hydraulic drive further comprises a second variable frequency drive, wherein the first variable frequency drive is configured to generate the front load data, and wherein the second variable frequency drive is configured to generate the rear load data.

### Example 15

The runway lift of any one or more of the preceding Examples, wherein the front lift comprises a primary control panel, and wherein the control unit is housed within the primary control panel.

### Example 16

A runway lift, comprising: (a) a front lift; (b) a rear lift; (c) a pair of runways extending between the front lift and the rear lift, wherein the front lift and the rear lift are configured to actuate the pair of runways between a lowered position and a raised position; (d) a front lift loading gauge configured to measure a front load data on the front lift, wherein the front load data indicates a front load magnitude being supported by the front lift; (e) a rear lift loading gauge configured to measure a rear load data on the rear lift wherein the rear load data indicates a rear load magnitude being supported by the rear lift; (f) a visual display; and (g) a control unit in communication with the front lift loading gauge, the rear lift loading gauge, and the visual display; wherein the control unit is configured to receive the front load data and the rear load data; wherein the control unit, based on either the front load data or the rear load data, is configured to detect an overloaded condition; wherein the control unit is configured to respond to detecting the overloaded condition by preventing the front lift and the rear lift from actuating the pair of runways toward the raised position; and wherein, based on the received front load data and the received rear load data, the control unit is configured to instruct the visual display to display the front load magnitude and the rear load magnitude while the runway lift is activated.

### Example 17

The runway lift of claim 16, wherein the visual display is configured to continuously display the front load magnitude and the rear load magnitude while the runway lift is activated.

### Example 18

A runway lift, comprising: (a) a first vertical post; (b) a second vertical post; (c) a runway extending between the first vertical post and the second vertical post; (d) an actuating carriage slidably attached to the first vertical post, wherein the actuating carriage is operatively connected to the runway, and wherein the actuating carriage comprises a yoke; (e) a hydraulic cylinder comprising a cylinder barrel and a piston rod, wherein the cylinder barrel is fixed relative to the first vertical post; and (f) a rod-to-yoke connection assembly connecting the piston rod to the yoke of the actuating carriage, and wherein the rod-to-yoke connection assembly is configured to allow pivotal movement between the piston rod and the actuating carriage.

### Example 19

The runway lift of Example 18, wherein the rod-to-yoke connection assembly comprises a connector adjustably attached to a terminating end of the piston rod.

### Example 20

The runway lift of Example 19, wherein the connector comprises a sleeve having internal threads configured to mesh with external threading on the piston rod, wherein the connector is configured to be longitudinally adjusted relative to the piston rod.

### III. Miscellaneous

It should be understood that any of the examples described herein may include various other features in addition to or in lieu of those described above. By way of example only, any of the examples described herein may also include one or more of the various features disclosed in any of the various references that are incorporated by reference herein.

When an act is described herein as occurring “as a function of” or “based on” a particular thing, the system is configured so that the act is performed in different ways depending on one or more characteristics of the thing.

It should be understood that any one or more of the teachings, expressions, embodiments, examples, etc. described herein may be combined with any one or more of the other teachings, expressions, embodiments, examples, etc. that are described herein. The above-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but that conflicts with existing definitions, statements, or other disclosure material set forth herein will only be incorporated to the extent that no conflict arises between that incorporated material and the existing disclosure material.

Having shown and described various versions of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

We claim:

1. A runway lift, comprising:
(a) a front lift;
(b) a rear lift;
(c) a pair of runways extending between the front lift and the rear lift, wherein the front lift and the rear lift are configured to actuate the pair of runways between a lowered position and a raised position;
(d) a front lift loading gauge configured to measure a front load data on the front lift as the pair of runways moves away from the lowered position toward the raised position;
(e) a rear lift loading gauge configured to measure a rear load data on the rear lift as the pair of runways moves away from the lowered position toward the raised position; and
(f) a control unit in communication with both the front lift loading gauge and the rear lift loading gauge, wherein the control unit is configured to receive the front load data and the rear load data, wherein the control unit is configured to determine if the front lift is overloaded using the front load data, wherein the control unit is configured to determine if the rear lift is overloaded using the rear load data, and wherein the control unit is configured to generate a signal in response to determining if the front lift is overloaded or if the rear lift is overloaded.

2. The runway lift of claim 1, wherein the control unit is configured to utilize the front load data to calculate a front load value.

3. The runway lift of claim 2, wherein the control unit is configured to utilize the rear load data to calculate a rear load value.

4. The runway lift of claim 3,
wherein the control unit stores a front lift predetermined threshold value and a rear lift predetermined threshold value; and
wherein the control unit is configured to compare the front lift predetermined threshold value against the front load value to determine if the front lift is overloaded.

5. The runway lift of claim 4, wherein the control unit is configured to compare the rear lift predetermined threshold value against the rear load value to determine if the rear lift is overloaded.

6. The runway lift of claim 1, wherein the control unit is configured to calculate of total load supported by the runway lift as the pair of runways moves from the lowered position toward the raised position.

7. The runway lift of claim 6,
wherein the control unit stores a total load predetermined threshold value, and
wherein the control unit is configured to compare the total load predetermined threshold value against the total load to determine whether the runway lift is overloaded.

8. The runway lift of claim 1, wherein the front lift comprises a front lift section, wherein the front lift section comprises a first pair of posts, wherein the rear lift comprises a rear lift section, and wherein the rear lift section comprises a second pair of posts.

9. The runway lift of claim 8, wherein the first pair of posts comprises a first cable equalizing system, and wherein the second pair of posts comprises a second cable equalizing system.

10. The runway lift of claim 8, wherein the first pair of posts comprises a first string potentiometer, and wherein the second pair of posts comprises a second string potentiometer.

11. The runway lift of claim 1, wherein the front lift comprises a first pair of hydraulic cylinders, and wherein the rear lift comprises a second pair of hydraulic cylinders.

12. The runway lift of claim 11, wherein the front lift comprises a first hydraulic drive configured to power the first pair of hydraulic cylinders, wherein the rear lift comprises a second hydraulic drive configured to power the second pair of hydraulic cylinders, wherein the first hydraulic drive comprises a first motor and a first pump, and wherein the second hydraulic drive comprises a second motor and a second pump.

13. The runway lift of claim 12, wherein the front lift loading gauge comprises a first pressure sensor configured to measure a pressure value within the first pair of hydraulic cylinders, wherein the rear lift loading gauge comprises a second pressure sensor configured to measure a pressure value within the second pair of hydraulic cylinders.

14. The runway lift of claim 12, wherein the first hydraulic drive further comprises a first variable frequency drive, wherein the second hydraulic drive further comprises a second variable frequency drive, wherein the first variable frequency drive is configured to generate the front load data, and wherein the second variable frequency drive is configured to generate the rear load data.

15. The runway lift of claim 1, wherein the front lift comprises a primary control panel, and wherein the control unit is housed within the primary control panel.

16. A runway lift, comprising:
(a) a front lift;
(b) a rear lift;
(c) a pair of runways extending between the front lift and the rear lift, wherein the front lift and the rear lift are configured to actuate the pair of runways between a lowered position and a raised position;
(d) a front lift loading gauge configured to measure a front load data on the front lift, wherein the front load data indicates a front load magnitude being supported by the front lift;
(e) a rear lift loading gauge configured to measure a rear load data on the rear lift wherein the rear load data indicates a rear load magnitude being supported by the rear lift;
(f) a visual display; and
(g) a control unit in communication with the front lift loading gauge, the rear lift loading gauge, and the visual display;
wherein the control unit is configured to receive the front load data and the rear load data, wherein the control unit, based on either the front load data or the rear load data, is configured to detect an overloaded condition,
wherein the control unit is configured to respond to detecting the overloaded condition by preventing the front lift and the rear lift from actuating the pair of runways toward the raised position, and
wherein, based on the received front load data and the received rear load data, the control unit is configured to instruct the visual display to display the front load magnitude and the rear load magnitude while the runway lift is activated.

17. The runway lift of claim 16, wherein the visual display is configured to continuously display the front load magnitude and the rear load magnitude while the runway lift is activated.

18. A runway lift, comprising:
(a) a first vertical post;
(b) a second vertical post;
(c) a runway extending between the first vertical post and the second vertical post;
(d) an actuating carriage slidably attached to the first vertical post, wherein the actuating carriage is operatively connected to the runway, and wherein the actuating carriage comprises a yoke;
(e) a hydraulic cylinder comprising a cylinder barrel and a piston rod, wherein the cylinder barrel is fixed relative to the first vertical post; and
(f) a rod-to-yoke connection assembly connecting the piston rod to the yoke of the actuating carriage, and wherein the rod-to-yoke connection assembly is configured to allow pivotal movement between the piston rod and the actuating carriage.

19. The runway lift of claim 18, wherein the rod-to-yoke connection assembly comprises a connector adjustably attached to a terminating end of the piston rod.

20. The runway lift of claim 19, wherein the connector comprises a sleeve having internal threads configured to mesh with external threading on the piston rod, wherein the connector is configured to be longitudinally adjusted relative to the piston rod.
